(19) United States
(12) Patent Application Publication
(10) Pub. No.: US 2012/0278414 A1
(43) Pub. Date: Nov. 1, 2012

(54) SYSTEM AND METHOD FOR ELECTRONIC EVENT CORRELATED MESSAGE DELIVERY

(76) Inventors: Tom Walsh, Tecumseh, MI (US); Steven J. Catani, Athens, GA (US); Maurice Collins, Chelsea, MI (US); Lauren Didyk, Plymouth, MI (US); Helene Gidley, Ann Arbor, MI (US); David Gregorka, Ann Arbor, MI (US); John Hetrick, Ann Arbor, MI (US); Jeff Matthes, Ypsilanti, MI (US); Tom Sox, Ambler, PA (US); Victor Strecher, Ann Arbor, MI (US)

(21) Appl. No.: 13/457,868

(22) Filed: Apr. 27, 2012

Related U.S. Application Data
(60) Provisional application No. 61/480,421, filed on Apr. 29, 2011.

(51) Int. Cl. G06F 15/16

(52) U.S. Cl. 709/206

(57) ABSTRACT

A method and system for providing personalized message delivery to one or more users is disclosed. In accordance with the method and system, data descriptive of two or more events in the one or more users' lives is gathered, analyzed and used to determine priority of messages; and personalized message delivery is provided to the one or more users based upon the priority of messages. The method and system may employ a predetermined objective associated with the one or more users to identify events and correlate holistic messages considered important by the user.

### CROSS REFERENCE TO RELATED APPLICATIONS

This application claims priority from U.S. Provisional Application Ser. No. 61/480,421, filed Apr. 29, 2011, the contents of which are hereby incorporated by reference in their entirety.

### FIELD OF THE INVENTION

The present invention relates to a method and system for providing message delivery to one or more users. The method and system of the invention, which employ event identification and correlation, are particularly useful in prioritizing messages considered important for the user.

### BACKGROUND OF THE INVENTION

Different methods and/or systems for the delivery of information to individuals are known. For example, U.S. Pat. No. 7,949,712 to AT&T Intellectual Property L.L.P., discloses a method for deploying a high availability presence engine for instant messaging that includes: receiving a user's presence change information in a global table; updating the global table to reflect the change in the user's presence information; and sending updated presence information on the user to local tables of contacts affected by the change in the user's presence; and U.S. Pat. Nos. 7,756,744 and 7,895,078 to Dotomi Inc. disclose a method for messaging over a data network, comprising: i) providing an Administration Server (AS) in which user portfolios are stored, said AS being in communication with a terminal belonging to a user; ii) allowing every registered user to generate and update one or more user portfolio(s) containing information relative to Providers and/or individuals the messages of which the user is willing to view; and iii) displaying to one or more users on their terminal messages according to the information contained in the user portfolio. While many of these methods and/or systems provide information to the user, they lack the intuitiveness to decide when the message will be most effective, based on learned patterns, user feedback, lack of user feedback and user preferences as well as what the content of the message should be.

Different methods and/or systems for assisting communication between members of a team are also known. For example, U.S. Pat. No. 8,069,131 to Luechtefeld et al. discloses an artificially intelligent or rule-based system to assist teams or groups by improving the communication process between members of the team or group. U.S. Pat. No. 7,996,257 to International Business Machines Corporation (hereinafter referred to as IBM) discloses mechanisms for collecting, calculating, and reporting quantifiable peer feedback on relative contributions of team members. U.S. Pat. No. 7,584,114 to IBM discloses a method for integrating project events on a team collaboration server with personal calendars. U.S. Pat. No. 7,072,940 to Ford Motor Company discloses methods and apparatus for managing data and information between diverse organizations and data management systems.

U.S. Published Application No. 20120036015 to Sheikh discloses a method to improve the relevancy of rendered advertising material to one or more consumers based on user-defined preferences, geolocation, and user-granted permission.

U.S. Published Application No. 20110112881 to Malhotra et al. discloses a system and method for helping users perform and manage actions on their to-do lists tasks by making it fun, rewarding and engaging. Malhotra et al. discloses that the system and method facilitate the interaction of a user with to-do list task items with those who can influence the user to take action and those that stand to benefit from the performance of the to-do list task items.

U.S. Pat. No. 8,126,712 to Nippon Telegraph and Telephone Corporation discloses an information communication terminal (100) that includes: a speech recognition module (6) for recognizing speech information to identify a plurality of words in the recognized speech information; a storage medium (20) for storing keyword extraction condition setting data (24) in which a condition for extracting a keyword is set; a keyword extraction module (8) for reading the keyword extraction condition setting data (24) to extract a plurality of keywords from the plurality of words; a related information acquisition module (11) for acquiring related information related to a plurality of keywords; and a related information output module (14) for providing related information to a monitor (2). The patent discloses that information communication terminal (100) may further include an emotion information processing module (51) and a speech output module (57). The emotion information processing module (51) includes an emotion recognition module (52), an emotion information transmission module (53), an emotion information reception module (54), and an emotion information display module (55).

U.S. Pat. No. 8,132,229 to International Business Machines Corporation (IBM) discloses a method and apparatus for controlling the distribution of data that, e.g., characterizes a user's emotional state or is capable of being used to characterize the user's emotional state and/or describes a physiological parameter. The patent discloses that a ruleset(s) is provided to regulate the distribution of the data to requesting applications. In order for an application to have access to the data, the relevant rules of the ruleset must be satisfied.

U.S. Pat. No. 8,125,314 to IBM discloses a method and system for determining user interest in media. The patent discloses that the method and system distinguish between user physical exertion biometric feedback and user emotional interest in a media stream.

U.S. Pat. No. 8,109,874 to Samsung Electronics Co., Ltd. discloses a mobile device capable of performing biomedical signal measurement and a health care method using the same. The patent discloses that the mobile device comprises a biomedical signal measurement module for detecting biomedical signals from a user's body, classifying the detected biomedical signals by respective signals and outputting the classified signals; and a health care module for analyzing a user's emotional state and physical condition based on the biomedical signals input from the biomedical signal measurement module and user's physical information.

Effective communication is vital. While the methods and/or systems discussed above may assist communication, they do not provide a method and/or a system that employs event identification and correlation to prioritize messages considered relevant for a user.

### SUMMARY OF THE INVENTION

The present invention is directed to a method for providing personalized message delivery to one or more users, comprising: gathering data descriptive of two or more events in the one or more users life, analyzing said data to identify events important to said user, wherein said identified events are determined based upon a predetermined objective associated with the one or more users; employing said identified events to determine priority of said messages; and providing said personalized message delivery to said one or more user.

The present invention is also directed to a system for providing personalized message delivery to one or more users, comprising: at least one user interface; a server, wherein said server comprises software, wherein said software gathers data descriptive of two or more events in the one or more users life, analyzes said data to identify events important to said user, wherein said identified events are determined based upon a predetermined objective associated with the one or more users ,and employs said identified events to determine priority of messages to determine personalized message delivery of said messages to said one or more users; and a transmitter in communication with said processor and said at least one user interface, wherein said transmitter provides said personalized message delivery of said messages to said one or more users through the at least one user interface.

### DESCRIPTION OF THE DRAWINGS

FIG. 1 is a flowchart showing an example of a method and system for providing message delivery to one or more users that may be used in accordance with the present invention.

FIG. 2 is a schematic that illustrates in more detail steps and the corresponding factors of those steps that may be implemented when using the method and system of the present invention.

FIG. 3 is a schematic that illustrates a general sequence of events that may be followed when using the method and system of the present invention.

FIG. 4 is a schematic that illustrates a server that may be employed when using the method and system of the present invention.

FIG. 5 is a schematic that illustrates how event identification and correlation may be employed to generate and deliver Holistic Messages when using the system and method of the present invention.

### DETAILED DESCRIPTION OF THE INVENTION

The present invention provides a method and system to correlate messages corresponding to identified events. The method and system of the invention permit effective communication to a user.

### Definitions

Unless defined otherwise, all technical terms used herein have the same meaning as commonly understood by one of ordinary skill in the art to which the invention belongs. Also, all publications, patent applications, patents, and other references that may be mentioned herein are incorporated herein by reference.

“Biometric Device Initiated Feedback” as used herein Biometric Device Initiated Feedback refers to information collected from one or more biometric devices that can allow for messaging based on the information and that help identify the effectiveness of each electronic message (i.e., mini-evaluation).

“Correlated Events” as' used herein Correlated Events generally have been evaluated (by the system) and a commonality has been identified between two or more linking the messages/events together in some macro or micro subject matter.

“Correlation Score” as used herein a Correlation Score can be a numerical value that shows how correlated two or more Events/messages are to each other.

“Economic Buyer” as used herein Economic Buyer generally includes an entity that promotes and/or sponsors a User's participation in a program that is based upon a common theme. For example, an Economic Buyer can be an employer, a health plan, a third party administrator, and/or a pharmaceutical company who pays for the program and/or selects and/or determines the scope of enrollment of the User in the program.

“Event(s)” as used herein Event(s) is/are data input to the system that is/are derived from various sources, including, but not limited to, User input.

“Geo-Social Data” as used herein Geo-Social Data includes data from the assessment of locations recorded using location-acquisition technologies (e.g., GPS, phone “check in” applications, etc.) that assist with generating life patterns, and which associate Users to places they frequently visit. Geo-Social Data includes Normative Data generated for a specific location recorded, or to similar locations.

“Holistic Message” as used herein a Holistic Message is generally a more eloquently constructed message, that is worded in such a way that pieces are not merely strung together but construction of the message as a whole is based on the sum of its parts. Messages are “holistically” created, as compared to the current form of “tailored” messaging, which is more like a series of prescripted messages packaged together in a logical way.

“Importance Score” as used herein an Importance Score generally includes a method of prioritizing Events and Correlated Event messages. For example, it may include the system assigning a numerical value to each specific Event or collectively to a group of Correlated Events by the system for prioritization.

“Just in Time Message (‘JIT Message’)” as used herein JIT Message is a personalized response that may be made in message form, advertisement, reminder, etc., which is conveyed effectively to the User by prioritizing and correlating the message using specific pertinent data prior to the conveyance. As indicated below, Just in Time indicates that the delivery is at the appropriate time, frequency, tone, method and/or mode of delivery for the message content in accordance with User's Preferences (includes both internal and external input).

“Message Combine” as used herein a Message Combine can act as a “think funnel”. I.e., micro events can be correlated with one another, and affect the overall Correlation Score of macro topics (e.g., cold outside>walking reminder>exercise>overall health>diabetes>reminder>blood sugar). Message Combine works on foundation messaging as the highest priority/highest level of correlation, then works down the scale of related Events (e.g., diabetes, depression, insomnia—messaging may focus on the central topic of exercise based on priority/effectiveness on all messages).

“Network Access Device” as used herein a Network Access Device means a device for accessing a communications network capable of transforming and receiving digital data.

“Normative Data” as used herein Normative Data includes data which represents the normal or average response or impact from any given event, (e.g., news, etc.), across various levels, (e.g., age, sex, etc.), used to compare a User's response with an objective external standard. Normative Data can also include data contained in available databases that provide population level data as a reference point.

“Now State” as used herein Now State means the best time, frequency, tone, method and/or mode for delivery of a message to a User as determined by an input describing the User's state of mind at a fixed point in time. The input could be from User input or derived from a reporting device.

“Overseer” as used herein an Overseer refers generally to a monitor for a Pre-determined Third Party. The Overseer may be a person or an algorithm that controls what messages are being sent and to whom. The Overseer may act as a filter, e.g., to prevent inappropriate messages coming from the Pre-determined Third Party. For example, an Economic Buyer may have a strict human resources (HR) policy that prevents certain types of messages from being generated. The Overseer could perform screening of messages in light of certain rules, evaluate the messages and accept, reject or adjust the messaging so it is appropriate given the environment/spirit in which it is being sent.

“Pre-determined Third Party” as used herein a Pre-determined Third Party may be a pre-selected team leader, party organizer, counselor, inspirational storyteller, Economic Buyer, etc. The Pre-determined Third Party may be selected by the Economic Buyer, the system itself, and/or the User. The function of the Pre-determined Third Party may be to motivate and direct the User(s). For example, the Pre-determined Third Party could motivate and organize people in an organization to, e.g., do good things, be healthy, be happy, be full of energy, etc.

“Present Responsiveness” as used herein Present Responsiveness is a determination of whether or not and how frequently a User responds to certain modalities and messages in order to determine the effectiveness of the messages.

“Real Time” as used herein Real Time is a process, action or transaction that involves updating information without artificial delay, i.e., at the same rate that the information is received.

“Smart Team Message(s)” as used herein a Smart Team Message is a communication to a User(s) that incorporates User's Preferences and a Team's characteristics/objectives to convey a message in a personalized and effective way by providing correlated and prioritized message delivery.

“Source Agnostic” as used herein Source Agnostic refers to all data being treated as input “events” without regard to their source. The data is formatted in a way that is not specific to its source (e.g., using standard protocols such as XML). The system may also use data from sources such as GPS location for mobile Users; weather information; geographical information; local events; time and date; news and current news, as well as the systems current sources (e.g., behavioral science, health and wellness, medical, health plan, employer data, etc.). This does not mean all data points are equal. Data is differentially weighted to impact how it is prioritized and/or used to construct messages.

“System Initiated Feedback” as used herein System Initiated Feedback generally refers to feedback from the system that helps determine the appropriate message by evaluating multiple data sources and events that pertain uniquely to the individual. In response to this unique information, the system uses pre-established rules to tailor messaging to the individual, with the rules structured so that the provided messaging is more effective than conventional messaging in positively affecting the User's actions and health outcomes. E.g., the system determines that the User needs positive reinforcement to not smoke at a particular time of day during his/her morning commute. This is a passive message based on the sum total of inputs relating to the User experience.

“Team” as used herein a Team generally includes individuals that share a set of qualities/characteristics used to achieve a common goal or target. E.g., athletic teams, business teams, support groups, members of an entity, etc.

“Transport Agnostic” as used herein Transport Agnostic includes data formatted to be used by multiple systems or devices (meaning standard data types and protocols are used so as not to restrict the data for any given system). Taken a step further, currently a User getting an e-mail may have a slightly different message than someone who accesses their information on the web. The system can ensure that the message(s) are formatted so that the meaning (core message) of the content is the same regardless of how they are received/transported.

“User” as used herein a User may be a person, team, company, or organization utilizing the message delivery system.

“User Initiated Feedback” as used herein User Initiated Feedback generally refers to feedback that is generated by the system as the result of an end User of the system triggering the feedback. It is different from System-Initiated Feedback, which is passive. I.e., User Initiated Feedback occurs when the User indicates they are in need of support, in need of feedback, or looking for specific information. For example, the User may communicate this need by direct input from a mobile device, a PC, or by other means (e.g., interactive voice response (IVR), kiosk, biometric or fitness measuring device).

“User's Preferences” as used herein User's Preferences are the preferences of a specific User as to the timing, frequency, message tone, method and/or mode of receiving/sharing information.

Commonly assigned co-pending U.S. application Ser. No. 13/283,039, filed on Nov. 27, 2011, entitled “METHOD AND SYSTEM FOR PERSONALIZED MESSAGE DELIVERY”, the entire contents of which are incorporated herein by reference, provides a method and system for determining and implementing user preferences, Normative Data, location, and time, including, e.g., time of day, day of week and month of year, for the delivery of Just in Time Messages in a way innocuous to the user.

Commonly assigned co-pending U.S. application Ser. No. 13/336,080, filed on Dec. 23, 2011, entitled “METHOD AND SYSTEM FOR AUTOMATED TEAM SUPPORT MESSAGE DELIVERY”, the entire contents of which are incorporated herein by reference, provides a method and system for providing message delivery to one or more members of one or more teams of users.

Commonly assigned co-pending U.S. application Ser. No. 61/480,408, filed on Apr. 29, 2011, entitled “METHOD AND SYSTEM FOR MESSAGE DELIVERY EMPLOYING THIRD PARTY INFLUENCES”, the entire contents of which are incorporated herein by reference, provides a method and system for providing message delivery to one or more users. The method and system, which employ user events and third party influences, are particularly useful in the correlation of messages considered important for the user.

Commonly assigned co-pending U.S. application Ser. No. 61/480,411, filed on Apr. 29, 2011, entitled “SYSTEM AND METHOD FOR USER INITIATED ELECTRONIC MESSAGING”, the entire contents of which are incorporated herein by reference, provides a method and system for providing message delivery to one or more users. The method and system, which employ user events, needs and emotions, are particularly useful in the correlation of messages considered important for the user.

The method and system of the invention, which employ event identification and correlation, are particularly useful in the prioritization of messages considered relevant for a user.

The invention is exemplified in the examples below.

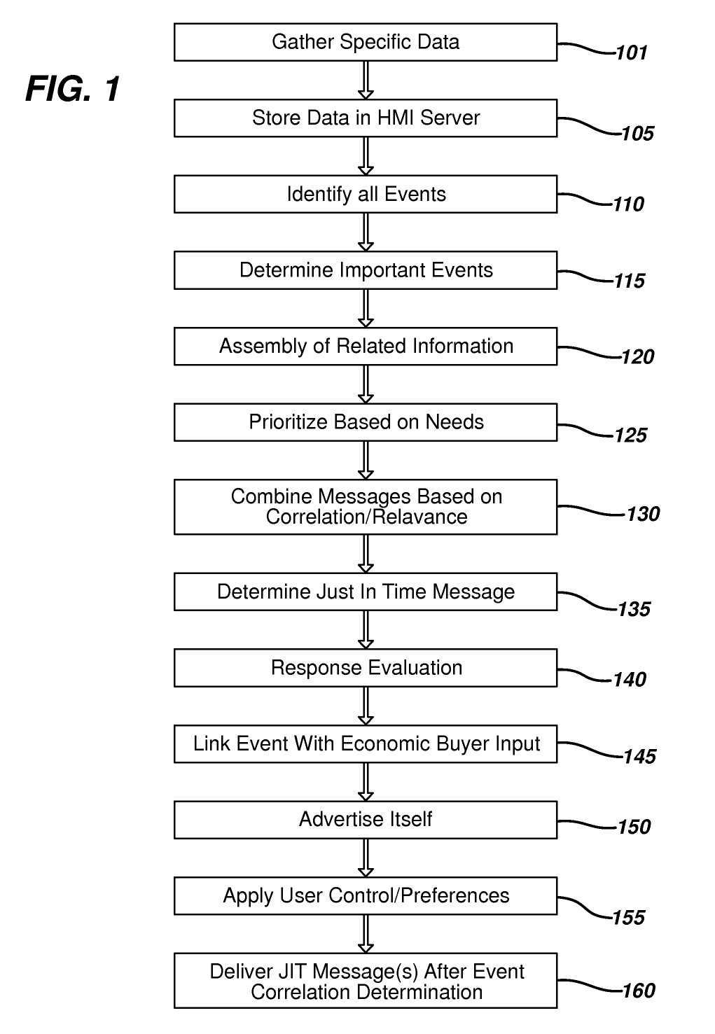

FIG. 1 is a flowchart showing an example of a method and system for providing message delivery to one or more users that may be used in accordance with the present invention. Referring to FIG. 1, people's time and attention span is limited. As such, for effective message construction, delivery, and assimilation, it would be useful to prioritize and correlate electronic messages to Events identified as important in the life of each particular User. According to an embodiment of the invention, at 101 the system gathers data specific to each User continuously. Data may come into a server from direct or indirect inputs, from the User, from a Pre-determined Third Party, and/or from different non-users, through one or more of an array of different Network Access Devices. At 105, data received in a consistent format and in Real Time can be supported by the system and may be stored in a designated database in the server. At 110, data received may be classified to indentify past events and/or anticipate upcoming events in the life of the User. After specific foreseeable events are identified, Events may then be linked with different behavioral topics by the system using User specific and Pre-determined Third Party data to determine an Importance Score for each Event generated 115. Upon formulating an Importance Score, at 120, the system may begin to combine information to assemble Holistic Messages to decrease the number of messages and maximize the effectiveness of the messages for the User.

At 125, the needs and/or User's Preferences can also be used by the System to prioritize the message(s). Further prioritization can occur and electronic messages may be generated and scheduled for delivery sequentially to specific future Events with a high probability of occurring 130. At 135, a JIT Message determination may also be implemented to determine effective means of delivery. At 140, the User or other comparable individual(s)' response(s) to an identical or similar message can generate data resulting from the effectiveness it has on the individual, which may be recorded for implementation in future determinations of content and delivery of the electronic messages.

Additional features may be implemented by the system. For example, the User's events and scope of participation can be limited by an Economic Buyer. The Economic Buyer can have power to customize the program causing it to focus on selected behavioral topics and/or elected Events 145 (i.e., event influenced electronic messages). The Economic Buyer may also use the system to “advertise itself” 150. The “advertise itself” option can allow the incorporation of pre-selected messages by the Economic Buyer into the program. The User's Preferences may also be merged with the Economic Buyer's settings to correlate events and scope of participation of the User 155. The system subsequently may cause the delivery of JIT Message(s) that are correlated with Events 155 providing effective conveyance of Holistic Messages to the User.

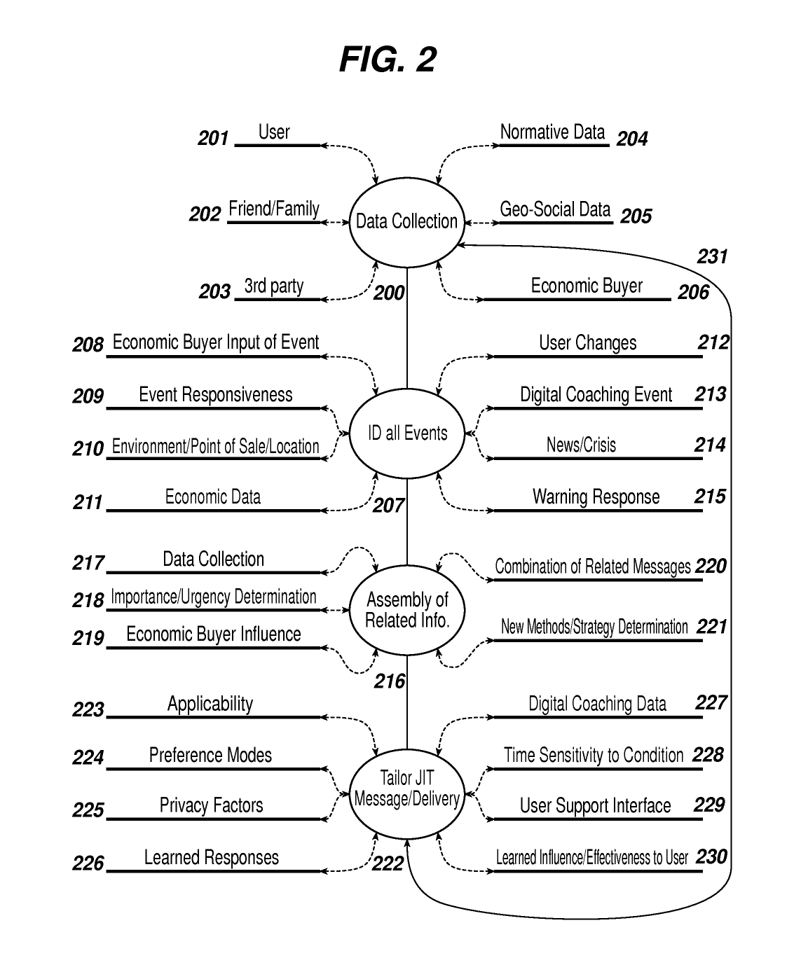

FIG. 2 is a schematic that illustrates in more detail the steps and corresponding factors of those steps that may be implemented when using the method and system of the present invention. Referring to FIG. 2, at 200, data collection applicable to the User can include data received from different avenues. The data received must be in a consistent format and in Real Time. The User 201 can supply data to the Network Access Device in different ways. User supplied data includes but is not limited to data taken from web/paper questionnaires/consultations, medical devices, the system itself, biometric devices, wireless devices, PC, employers, etc.

Friends and family 202 may also provide relevant information about the User through different/same mediums. They can express concerns or provide valuable information about the User through any medium supported by the system. An example of a medium that may be implemented without burdening this group is social networks. Social networks are used every day and may provide Source Agnostic information in Real Time, about the User, without requiring additional effort from friends and family.

Third parties 203 may also provide helpful and in some applications valuable data to the system. Such third parties include the User's Economic Buyer, physician, coach, co-worker, manager, project manager, etc. These third parties, who can provide data in everyday situations using mediums supported by the system, may give useful/essential data to the system for specific topics. For example, in one scenario where a third party notices or notes a change in the individual's activities, preferences, or behavior, the system may detect the change from the data provided by the third party. In another scenario, the Economic Buyer may elect certain behavioral topics, assessments, modes, etc. for implementation by the system 206.

Normative Data 204 and Geo-Social Data 205 can also help identify, correlate and associate responsiveness of messages to particular Events and/or goals/objectives. An example of where Normative Data may be useful includes data collected from a reaction to an Event from a particular group of people who share similar characteristics. The system can categorize, prioritize and correlate the data received which resulted from the reaction to the Event into the Importance Score determination. Finally, data generated from the response and effect of these, Smart Team Messages and/or JIT messages is Source and/or Transport Agnostic, which may be used by the system to determine User Preferences for future interaction and Holistic Messages.

Using algorithms capable of applying sets of factors and Correlation Scores, the system may identify those Events important to the User 207. Events can subsequently be tagged/categorized using the additional factors. Additional factors that can influence electronic messages may include but are not limited to Economic Buyer Input of Events 208, responsiveness to an Event 209, location/environment where an Event takes place 210, economic data 211, User's Preferences 212, a digital coaching Event created by the system 213, current news data 214, responses to Event warnings 215, etc. These factors for the Importance Score determination can be programmed into the algorithms in the server and the system can allow inputs from the monitoring party for the modification of these to maximize the effectiveness of the program.

After obtaining the Correlation Score for identified Events, the system can gather pertinent information for Holistic Message assembly using the information collected and stored in the systems databases 216. The content of the message may be determined using the Event(s)' information/data 217. Behavioral science inputs can allow for an Importance Score determination for the information/data. The Importance Score determination will manipulate the content of messages and the priority among the messages generated 218. Other things aside from behavioral science can also be used for content and priority determination. For example, an Economic Buyer may manipulate the content of the message 219. An example of how/when this may occur is when the Economic Buyer chooses to advertise itself by selecting preselected messages from the system.

After the content and priority determination, the system can use a Message Combine 220 to provide Holistic Message(s), which can minimize the amount of messages and increase the probability of effective reception of the message by the User. Using behavioral science, the system can also strategize the messages and provide new methods of delivery generating data to tailor the delivery and content of future messages 221. For example, in some applications, a Holistic Message can be Event triggered by a manager but delivered by the Pre-determined Third Party influence to ensure a positive effective message result.

The conveyance timing and method of the message may be tailored to the User using JIT Messaging 222. Determining the applicability of the message in relation to an activity the User may be performing/taking part in, can ensure that the message is engaging, thus maximizing the effectiveness of the message 223. For example, by using the data collected to track the User's everyday activities, the system can correlate specific messages with high probability occurring activities to specific times of the day, month, etc. The User Preferences and access to devices at specific times is also taken into account in the delivery 224. For example, it can be determined that the User has access to a computer during workday hours specific to the User. Additionally, privacy factors and access to information can be protected to protect the individual's privacy and ensure truthful participation of the User 225. The system may also learn responses from the User and shape the program accordingly 226.

Digital coaching may also be possible 227. The Economic Buyer, Pre-determined Third Party, or System can recommend or assign a coach or a digital “buddy” for encouragement. The interaction of more than one User in the program can be done by invitation and be known to Users, or can remain anonymous if desired. Coaches may also be recruited by the system based on Biometric Device Initiated Feedback, System Initiated Feedback, and/or User Initiated Feedback and data inputted/collected from them is weighted for the electronic messages accordingly.

At 228 the participation of the User may be tracked and time factors specific to the User can be implemented in the delivery of the message. For example, for some Users it may be more effective to convey the message as close to the occurrence of the Event vs. others, as soon as possible to allow for anticipation and preparation accordingly. In addition, the User can be more susceptible to adequate reception of the particular message when he/she is happy, sad, focused, etc., consequently, the system also correlates the optimal state of mind for reception of the particular message. User Preferences can also be adapted through User support interfaces that allow for unexpected changes 229. Learned influences and effectiveness to a User after change can be tracked and recorded for future assessment increasing effectiveness of the system with time 230, 231.

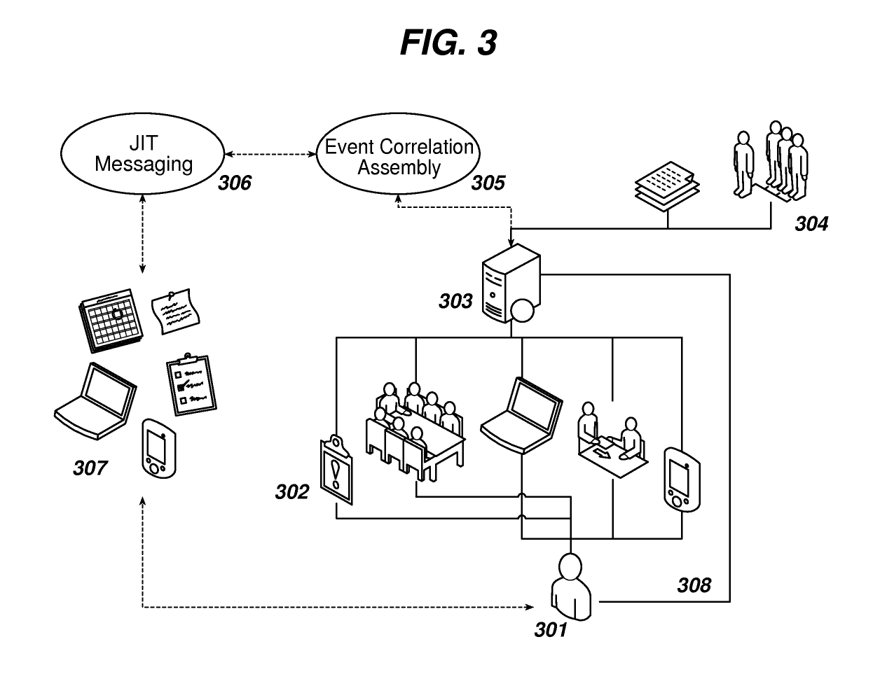

FIG. 3 is a schematic that illustrates a general sequence of events that may be followed when using the method and system of the present invention. Referring to FIG. 3, the User 301 of the system directly or indirectly provides data through different avenues 302. The data is gathered by a main server 303, which also collects other information 304 that includes but is not limited to Normative Data and Geo-Social Data, as explained above. The main server 303 contains software executable to perform the functions described above providing Event Correlated Messaging 305 for the delivery of Holistic Message(s) to the User(s) 306. The message can be conveyed using the User Preferred means for the message and collect Present Responsiveness data throughout to update/increase preciseness of the systems functions for subsequent prospect messages 307, 308.

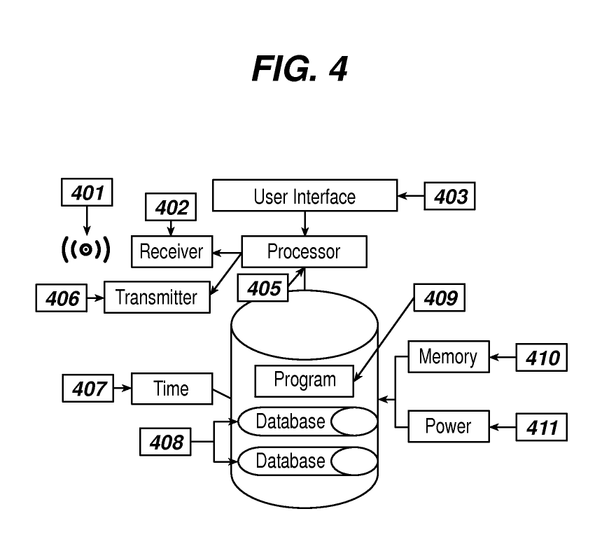

FIG. 4 is a schematic that illustrates a server that may be employed when using the method and system of the present invention. Referring to FIG. 4, the server can contain different means of receiving information 401. For example, Bluetooth technology, network/internet capabilities, etc. A receiver 402 can be used to allow the processor 405 to cause the data to be stored in specific databases 408 in uniform format and time. The data can then be used by a program 409 executable to perform the functions as described above by means of a series of algorithms. The server can additionally include a User interface 403, a processor for the software 405, a means of power 411, memory 410, and a means of keeping Real Time 407 in relation to the specific location of the individual (e.g., connecting the User's cell phone to the system to change time accordingly when required due to the User traveling.) A transmitter 406 in logical communication with the processor 405 transmits one or more Holistic Messages to one or more Network Access Devices associated with the User (not shown) based upon the order of precedence, the Now State and the priority of messages as described above.

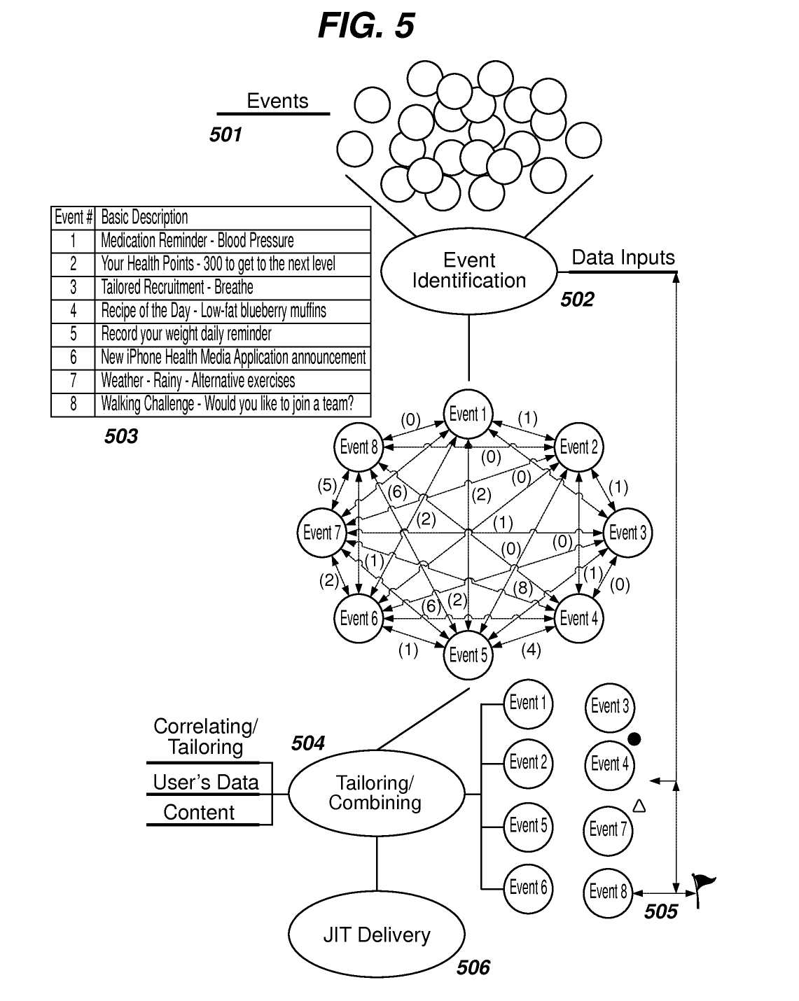

FIG. 5 is a schematic that illustrates how event identification and correlation may be employed to generate and deliver Holistic Messages when using the system and method of the present invention. Referring to FIG. 5, as previously described, data gathered and stored may give rise to specific Events 501. These Events can be identified by the system accordingly from the data inputs 502. In the present example, eight Events were identified 503 (the number of Events is not limited by the system but by the settings and the amount of information gathered/participation of the User). Subsequently, the Events can go through an evaluation on a set of behavioral topics predetermined by behavioral scientists, medical consultants, Normative Data, Geo-Social data, etc. Consequently, the Events are correlated to a topic and each correlation can contain a score and a reason (i.e., a business rule(s)) as to why it is correlated as such.

In this case, the eight Events were correlated to weight loss. A correlation graph for weight loss that may be used in the system is shown 502. The correlation graph can be created using behavioral science, statistical data, Geo-Social data, etc. and can be supplemented/updated at any time. The graph can be used to tailor, Message Combine, and/or prioritize the collected information gathered with specific Events 504. This collection of information priority can be based on another algorithm that can be influenced by the highest single Event priority outlier in the collection. The information is tailored to produce an Event Correlated Holistic Message from the collection of Events. Additionally, the topics may be merged with the use of the reason that the Correlation Score was high. This can allow the system to construct messages much like how a weight loss coach would, i.e., digital coaching. In this scenario, a possible message generated from these Events can be, “don't let the rain slow you down, even though the weather is rainy you can still stay on track. Try replacing your daily walk with one of these activities: (1) mall walking—catch up on your window shopping while you get in your steps, (2) yoga—let's try something new, click here to find local yoga sessions, etc.” If the Team Support option was selected in this scenario, the message could be supplemented to provide support accordingly with a message such as, “While we are on the subject of exercises have you ever considered joining a walking team. With your 1200 steps a day you could help “Team A” in their attempt to overtake “Team B” from their top spot.”

If the system determines that combining information is appropriate in relation to the User's Events 505, the message generated could be, e.g., “It is important to keep eating healthy to meet your weight loss goals. You might want to try our recipe for low-fat wholegrain blueberry muffins to charge you up to meet your walking goals and maintain your weight loss.”

For Events not in a correlation group, a single Event may create a correlation group. For example, Event 1 was a medication reminder from a Pre-determined Third Party being the User's primary physician—blood pressure, and that is extremely important but not correlated with any other events. This Event can form groups using event message priority in the system. After this group is determined, the priority may still be greater than a large correlation like the one in the previous example. This can be done because the algorithms can score priority on high outliers. For instance, if the highest priority Event in the first example was 5, the total priority score might be something similar to 5, 7. The medication reminder priority itself might be something like 9, so it can be higher. The system may subsequently determine the number of Event Correlated Holistic Messages that are appropriate and cause JIT delivery for each one 506.

In addition to passive System Initiated Feedback that evolves over time, the system can also support User Initiated Feedback or activity through portable devices that provide the User with the option of interaction with the system. The interaction between the system and User can be an evolving loop, where new information fed by the User is considered along with new information from external sources and System Initiated Events when new messages are crafted. Based on portable devices, some that can be worn, the end User can influence the system for a new response. Some of the User worn devices can include for example, GPS, pedometer, glucose meter, etc. Through these devices, the system receives new Event data, including, e.g., Biometric Device Initiated Feedback, and subsequently may incorporate it into the message generation. As a result, messages can continue to evolve over time, and the system can learn subtleties about the User that were not possible in past messaging models or with User self-reported data alone.

The foregoing examples are not intended to limit the scope of the present invention, which may be set out in the claims. In particular, various equivalents and substitutions will be recognized by those skilled in the art in view of the foregoing disclosure and these are contemplated to be within the scope of the invention.

What is claimed is:

1. A method for providing personalized message delivery to one or more users, comprising:
gathering data descriptive of two or more events in the one or more users life, analyzing said data to identify events important to said user, wherein said identified events are determined based upon a predetermined objective associated with the one or more users;
employing said identified events to determine priority of said messages; and
providing said personalized message delivery to said one or more user.

2. The method of claim 1, wherein the priority of said messages is also based upon behavioral science in relation to the one or more predetermined objectives associated with the one or more users.

3. The method of claim 1, wherein the priority of said messages is also based upon the user's state of mind at a fixed point in time.

4. A system for providing personalized message delivery to one or more users, comprising:
at least one user interface;
a server, wherein said server comprises software, wherein said software gathers data descriptive of two or more events in the one or more users life, analyzes said data to identify events important to said user, wherein said identified events are determined based upon a predetermined objective associated with the one or more users ,and employs said identified events to determine priority of messages to determine personalized message delivery of said messages to said one or more users; and
a transmitter in communication with said processor and said at least one user interface, wherein said transmitter provides said personalized message delivery of said messages to said one or more users through the at least one user interface.

5. Apparatus for providing information to a user, the apparatus comprising:
a computer processor in digital communication with a digital media storage device, wherein the digital media storage device stores executable software code; and
a transmitter in logical communication with the processor and also in logical communication with a communication network;
wherein, the software is executable upon demand and operative with processor to transmit and receive digital data via the transmitter and:
receive and store digital data descriptive of a plurality of Events associated with a User;
determine an order of precedence of records descriptive of events in a User's life based a predetermined objectives associated with the User;
receive data descriptive of a Now State of the User;
generate a priority of messages stored on the media storage, wherein the priority is based upon behavioral science in relation to the events and the Now State; and
transmit one or more messages to a network access device associated with the user based upon the order of precedence of the user, the Now State and the determined priority of messages.

6. The apparatus of claim 5, wherein the software is additionally operative to Message Combine based upon one or both of a Correlation Score and a predetermined relevance.

7. The apparatus of claim 5, wherein the software is additionally operative allow additional inputs to influence the order of precedence.

8. The apparatus of claim 7, wherein the software is additionally operative to allow merging the additional inputs with the order of precedence of the user, learned responses and the Now State for the priority determination.

9. The apparatus of claim 5, wherein the digital data descriptive of a plurality of Events associated with a User is received from multiple disparate inputs and multiple disparate sources.
